(19) United States
(12) Patent Application Publication
(10) Pub. No.: US 2007/0160705 A1
(43) Pub. Date: Jul. 12, 2007

(54) Apparatus and method for manufacturing ceramic ware

(76) Inventor: Jea-Sam Lee, Seoul (KR)

Correspondence Address: IPLA P.A., 3580 WILSHIRE BLVD., 17TH FLOOR, LOS ANGELES, CA, 90010, US

(21) Appl. No.: 10/597,744

(22) PCT Filed: Feb. 18, 2005
(86) PCT No.: PCT/KR05/00458

§ 371 Date: Aug. 4, 2006

(30) Foreign Application Priority Data
Feb. 19, 2004 (KR) 10-2004-0011165

(51) Int. Cl. B29C 45/40; B28B 1/00

(52) U.S. Cl. 425/436 R; 264/680

(57) ABSTRACT

An apparatus and a method for manufacturing ceramic ware are disclosed. The apparatus has a pair of mold housings, each having a wire net formed in a housing frame so as to support a mold. An air ejection tube fixed to the wire net is formed of fibroid material so as to eject the air toward the inside of the mold. The apparatus further has support plates for fixedly supporting the mold housing, and hydraulic cylinders for driving the support plates. An air compressor provides the air to the air ejection tubes of the mold housings. The method includes preparing a lump of clay, cutting the clay into slab clays, inserting the slab clay into the mold housing, pressing and casting the slab clay into a desired clay piece, drying the clay piece, decorating the clay piece, and firing the clay piece.

### TECHNICAL FIELD

The present invention relates generally to the technology of making objects of ceramic and, more particularly, to an apparatus and a method for manufacturing ceramic ware.

### BACKGROUND ART

The term ceramic ware refers to all objects made of fired clay. The ceramic ware is commonly made from clay that is molded into a desired shape, decorated, glazed, and fired. The ceramic ware has been widely used for vase, dish, tableware, etc., and further, recently used for construction materials such as traditional bricks, tiles, or plates.

A method for manufacturing the ceramic ware through a wet process includes pouring clay or slip into a mold with a desired inner surface pattern and pressing the mold to transfer the pattern onto the clay. In this process, oiled paper or vinyl film is interposed between the clay and the mold so as to allow an easy separation of the clay from the mold.

### DISCLOSURE OF INVENTION

### Technical Problem

An example of such a conventional method is described in Korean Patent No. 10-1985-0001421 B1, entitled molding process for pottery

According to the above disclosure, the patterned mold is made of epoxy resin. A surface of the mold is covered with the vinyl film having a thickness of about 0.001 mm, and then the clay is provided thereon and pressed. After the vinyl film is removed, the molded clay is separated from the mold.

As discussed, the conventional method has to use the oiled paper or vinyl film so as to prevent adhesion between the clay and the mold. Unfortunately, this may cause the air to remain in intaglio space of the inner surface pattern of the mold. So, the pattern of the mold may often fail to be transferred onto the clay, which results in poor or indistinct pattern. Furthermore, since forming an elaborate pattern requires uniform pressure on the clay, the clay to be molded may be subjected to restrictions on size, shape, and dampness. This may often invite distortion or deformation of the molded clay when the clay is dried or fired.

In addition, the vinyl film is sometimes damaged by pressure, so it may be difficult to obtain a desired shape of the molded clay. Besides, since the vinyl film is removed by hand, it may be difficult to automatize the wet molding process.

### Technical Solution

It is therefore an object of the present invention to provide a new and improved apparatus for manufacturing ceramic ware.

Another object of the present invention is to provide a new and improved method for manufacturing ceramic ware.

### Advantageous Effects

As discussed above, the present invention provides many effects and advantages.

Since the air is supplied between the mold and the clay piece, creating an air film, it is easy to separate the clay piece from the mold.

Further, since no foreign matter is required for the separation of the clay piece, the ceramic ware having desired pattern and shape can be obtained.

In addition, since no typical vinyl film is used, a process of removing the vinyl film is eliminated.

Also, since the air is supplied with the amount and time thereof regulated, it is possible to automatize the molding process of the ceramic ware.

Moreover, the apparatus and method of the invention can manufacture ceramic wares having an elaborate pattern, used for construction materials such as traditional bricks, tiles, or plates, with simpler process and lower production cost.

### BRIEF DESCRIPTION OF THE DRAWINGS

FIG. 1A is a perspective view showing a mold housing for ceramic ware in accordance with an exemplary embodiment of the present invention.

FIG. 1B is an enlarged view showing an air ejection tube of the mold housing shown in FIG. 1A.

FIG. 2 is a perspective view showing an apparatus for manufacturing ceramic ware in accordance with an exemplary embodiment of the present invention.

FIG. 3 is a flow diagram showing a method for manufacturing ceramic ware in accordance with an exemplary embodiment of the present invention.

### BEST MODE FOR CARRYING OUT THE INVENTION

Exemplary, non-limiting embodiments of the present invention will now be described more fully hereinafter with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and feature of this invention may be employed in varied and numerous embodiments without departing from the scope of the invention.

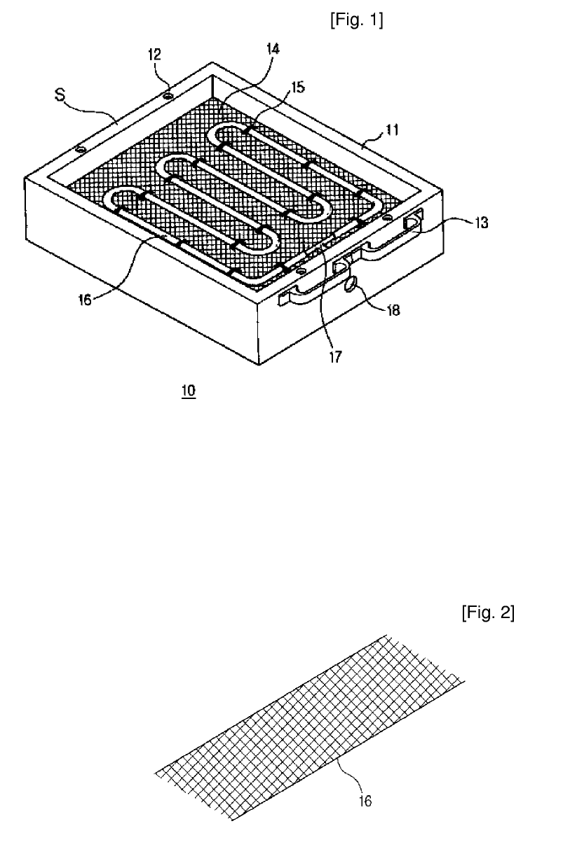

FIG. 1A is a perspective view showing a mold housing 10 for ceramic ware in accordance with an exemplary embodiment of the present invention. FIG. 1B is an enlarged view showing an air ejection tube 16 of the mold housing 10 shown in FIG. 1A.

Referring to FIGS. 1A and lB, the mold housing 10 includes a housing frame 11, which may be formed of nonferrous metals such as rustproof aluminum alloy. The housing frame 11 may be alternatively formed of reinforced plastics or many other materials having enough stiffness to endure a compressive force.

The housing frame 11 has several holes 12 in and along its upper face (denoted by S). When corresponding two mold housings are combined, the holes 12 receive pins (not shown) of the other housing frame so as to allow coincidence in position.

A wire net 14 is formed in the entire inside of the housing frame 11. Preferably, the wire net 14 is located at a distance of about 2˜3 centimeters from the upper face (S) of the housing frame 11. As will be discussed below, such distance allows free passage of the air along the outside of a gypsum mold covered with the wire net 14.

The housing frame 11 further has an air supply hole 18 at the center of its one sidewall. A typical hook (not shown) may be used for the air supply hole 18 so as to facilitate connection with and separation from any other objects.

The housing frame 11 also has a handle 13 near the air supply hole 18 so as to be held or operated with hand.

The wire net 14 is provided with the air ejection tube 16 used to eject the air toward the inside of the gypsum mold. The air ejection tube 16 is fixed to the wire net 14 with a small wire 15. As shown in FIG. 1B, the air ejection tube 16 is formed of fibroid material and shaped into cylindrical openwork fabric. This peculiar structure of the air ejection tube 16 may allow free ejection of the air from the inside to the outside.

The air ejection tube 16 is connected to a T-shaped pipe 17, which is combined with the air supply hole 18.

### Mode for the Invention

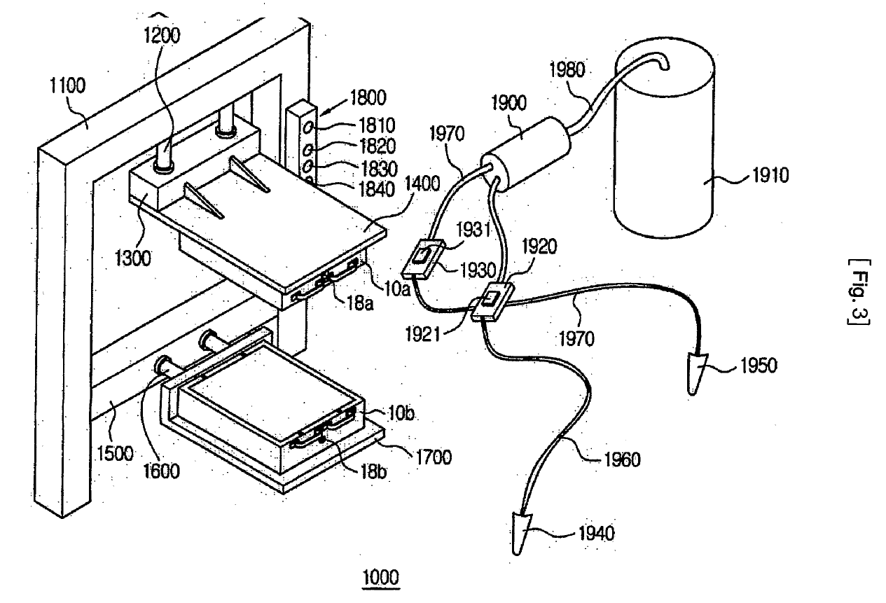

FIG. 2 is a perspective view showing an apparatus 1000 for manufacturing ceramic ware in accordance with an exemplary embodiment of the present invention.

Referring to FIG. 2, the apparatus 1000 includes a main frame 1100 that is fixed to the ground.

The main frame 1100 has a secondary frame 1500 at its predetermined position.

A first hydraulic cylinder 1200 is provided to an upper part of the main frame 1100.

The first hydraulic cylinder 1200 is connected to a cylinder body 1300, which is combined with a first support plate 1400. An upper mold housing 10a (a first mold housing, the same one as discussed above) is fixedly supported to the first support plate 1400.

The first support plate 1400 can move up and down by driving of the first hydraulic cylinder 1200.

A second hydraulic cylinder 1600 is provided to the secondary frame 1500. The second hydraulic cylinder 1600 is connected to a second support plate 1700. A lower mold housing 1Ob (a second mold housing, the same one as discussed above) is fixedly supported to the second support plate 1700.

The second support plate 1700 can move back and forth by driving of the second hydraulic cylinder 1600.

Additionally, the main frame 1100 is provided with a control box 1800, which includes a power switch 1810 and several kinds of sensors 1820, 1830 and 1840. The sensors 1820, 1830 and 1840 are used to regulate the amount of the air supplied into the molds within the mold housings 10a and 10b, the air supply time, and the pressing intensity.

The apparatus 1000 further includes an air compressor 1900, which is provided separately from the main frame 1100.

The air compressor 1900 sends the compressed air into the molds within the mold housings 10a and 10b. The air compressor 1900 is connected to an air tank 1910 storing the compressed air through a third hose 1980.

The air compressor 1900 is further connected to a first switch 1920 and a second switch 1930 through a first hose 1960 and a second hose 1970, respectively. The first and second switches 1920 and 1930 are used to open or break the air current toward the mold housings 10a and 10b.

The first and second hoses 1960 and 1970 are also connected to a first hook 1940 and a second hook 1950, respectively. Each switch 1920 and 1930 further has a button 1921 and 1931 for operation.

The first hook 1940 is connected to a first air supply hole 18a formed in the upper mold housing 10a, and the second hook 1950 is connected to a second air supply hole 18b formed in the lower mold housing 10b.

It is therefore possible to regulate the amount of the air supplied into the upper and lower mold housings 10a and 10b.

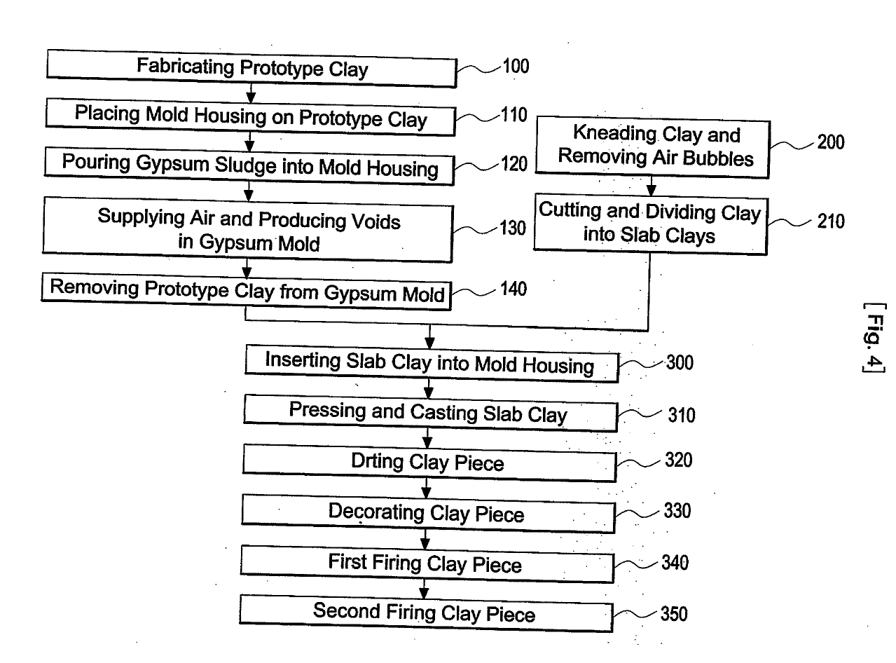

FIG. 3 is a flow diagram showing a method for manufacturing ceramic ware in accordance with an exemplary embodiment of the present invention.

Referring to FIG. 3, the method according to the embodiment includes and starts from two independent procedures. A first procedure is to form a gypsum mold, whereas a second procedure is to prepare clay slip. The first and second procedures are separately carried out regardless of order.

The first procedure is as follows.

First of all, prototype clay having a desired shape is fabricated from suitable clay (step 100).

Next, the prototype clay is laid on a flat ground, and an overturned mold housing is placed on the prototype clay (step 110).

Next, gypsum sludge in semi-liquid state is poured into the mold housing (step 120).

Next, while the gypsum sludge is solidified, and the air is supplied so as to produce voids in the gypsum mold (step 130). In this step, the supply of the air is made at the time when more than fifty percent of the gypsum sludge is solidified. The air current removes moisture from the voids in the gypsum mold such that the voids can be completely formed to the outside.

Next, the prototype clay is removed from the solidified gypsum mold (step 140).

The second procedure is as follows.

First of all, clay is kneaded such that air bubbles are removed from the kneaded clay (step 200). In this step, inorganic materials are mixed in regular ratios, and further, sandy soil is added thereto. Then the materials in minute particle state are kneaded with water.

Next, a lump of clay is cut and divided into clay bodies of a suitable size for the second mold housing (step 210). The cut clay body has a slab shape.

After the first and second procedures are finished, the undermentioned steps follow.

The cut slab clay is inserted into the second mold housing (step 300). Preferably, the slab clay has room temperature and moisture content of 15˜20 weight percent.

Next, the slab clay is pressed and cast (step 310). The third sensor 1840 of the control box regulates the pressing intensity. The moment the pressing operation begins, the second sensor 1830 allows the air supplying operation and regulates the air supply time. The pressing time may be set to several seconds, preferably 1˜2 seconds, and the air is continuously supplied during the pressing operation.

Next, the cast clay piece is separated from the mold housing and then dried (step 320). The drying step may be performed through heat drying or natural seasoning.

Next, the dried clay piece is engraved with a pattern, and glaze material is applied to the patterned clay piece (step 330). Before or after glazing, a picture may be made on the surface of the clay piece.

Next, the decorated clay piece is fired (step 340). The primary firing may be carried out in the kiln at a temperature of 700˜1000.

Finally, the fired clay piece is fired again (step 350). The secondary firing may be carried out in the kiln at a temperature of 1250˜1350.

### INDUSTRIAL APPLICABILITY

While this invention has been particularly shown and described with reference to exemplary embodiments thereof, it will be understood by those skilled in the art that various changes in form and details may be made therein without departing from the spirit and scope of the invention as defined by the appended claims.

1. An apparatus for manufacturing ceramic ware, the apparatus comprising:
a first mold housing and a second mold housing, each of which includes a housing frame, a wire net formed in the housing frame so as to support a mold, an air ejection tube fixed to the wire net and formed of fibroid material so as to eject the air toward the inside of the mold, and an air supply hole formed in the housing frame and connected to the air ejection tube so as to supply the air;
a first support means for fixedly supporting the first mold housing;
a second support means for fixedly supporting the second mold housing;
a first drive means for moving up and down the first support means;
a second drive means for moving back and forth the second support means;
an air supply means for providing the air to the air supply holes of the first and second mold housings; and
a control means for regulating the amount of the air, the air supply time, and the pressing intensity between the first and second mold housings.

2. The apparatus of claim 1, wherein each drive means is a hydraulic cylinder, and wherein the wire net of each mold housing is located at a distance of about 2˜3 centimeters from the upper face of the housing frame.

3. A method for manufacturing ceramic ware using the apparatus of claim 1, the method comprising:
a step of preparing a lump of clay, wherein the clay is kneaded such that air bubbles are removed from the clay;
a step of cutting the clay such that the clay is divided into slab clays of a suitable size for the mold housing;
a step of inserting the slab clay into the mold housing;
a step of pressing and casting the slab clay into a desired clay piece;
a step of drying the clay piece;
a step of decorating the clay piece, wherein the clay piece is engraved with a pattern, and wherein glaze material is applied to the clay piece; and
a step of firing the clay piece.

4. The method of claim 3, further comprising:
a step of fabricating prototype clay from suitable clay;
a step of placing the overturned mold housing on the prototype clay;
a step of pouring gypsum sludge into the mold housing;
a step of supplying the air so as to produce voids in a gypsum mold, while the gypsum sludge is solidified into the gypsum mold; and
a step of removing the prototype clay from the gypsum mold.

5. The method of claim 4, wherein the slab clay, inserted into the mold housing, has room temperature and moisture content of 15˜20 weight percent.

6. The method of claim 4, wherein the step of pressing and casting includes continuously supplying the air.

7. The method of claim 4, wherein the pressing time in the step of pressing and casting is set to 1˜2 seconds.
